(19) United States
(12) Patent Application Publication
(10) Pub. No.: US 2014/0009849 A1
(43) Pub. Date: Jan. 9, 2014

(54) HARD DISK HAVING FUNCTION OF OUTPUTTING WORKING STATE

(71) Applicants: HON HAI PRECISION INDUSTRY CO., LTD., New Taipei (TW); HONG FU JIN PRECISION INDUSTRY (ShenZhen) CO., LTD, ShenZhen (CN)

(72) Inventors: BO TIAN, Shenzhen (CN); KANG WU, Shenzhen (CN)

(21) Appl. No.: 13/933,156

(22) Filed: Jul. 2, 2013

(30) Foreign Application Priority Data
Jul. 6, 2012 (CN) 2012102334084

(51) Int. Cl. G11B 27/36

(52) U.S. Cl. CPC G11B 27/36
USPC 360/31

(57) ABSTRACT

A hard disk of a computer system includes a platter, a spindle motor, a magnetic head, a cache, an interface for connections, and a main control chip. The main control chip within the hard disk detects whether or not each of the cache, the platter, the spindle motor, and the magnetic head are individually working normally. When any of the cache, the platter, the spindle motor, and the magnetic head is not working normally, the main control chip outputs a signal accordingly to an external device connected to the interface.

### BACKGROUND

1. Technical Field

Embodiments of the present disclosure relate to computer systems, and particularly to, a hard disk of a computer system having a function of outputting the working state of the hard disk.

2. Description of Related Art

Hard disks (HDs) are components for computer systems to provide data storage functions. It is important for a computer system to monitor a working state of the hard disk. In some particular solutions, a detection circuit for detecting the working state of a hard disk is provided on a motherboard of the computer system. The detection circuit may monitor signals from data input/output (I/O) ports of the hard disk to detect whether or not the working state of the hard disk is normal. However, a plurality of data lines are needed to establish a connection between the detection circuit and the data I/O ports of the hard disk, which may cause interference or otherwise influence other circuits of the motherboard. Therefore, there is room for improvement in the art.

### BRIEF DESCRIPTION OF THE DRAWINGS

FIG. 1 illustrates a schematic block diagram of one embodiment of a hard disk.

FIG. 2 illustrates a schematic block diagram of another embodiment of the hard disk of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

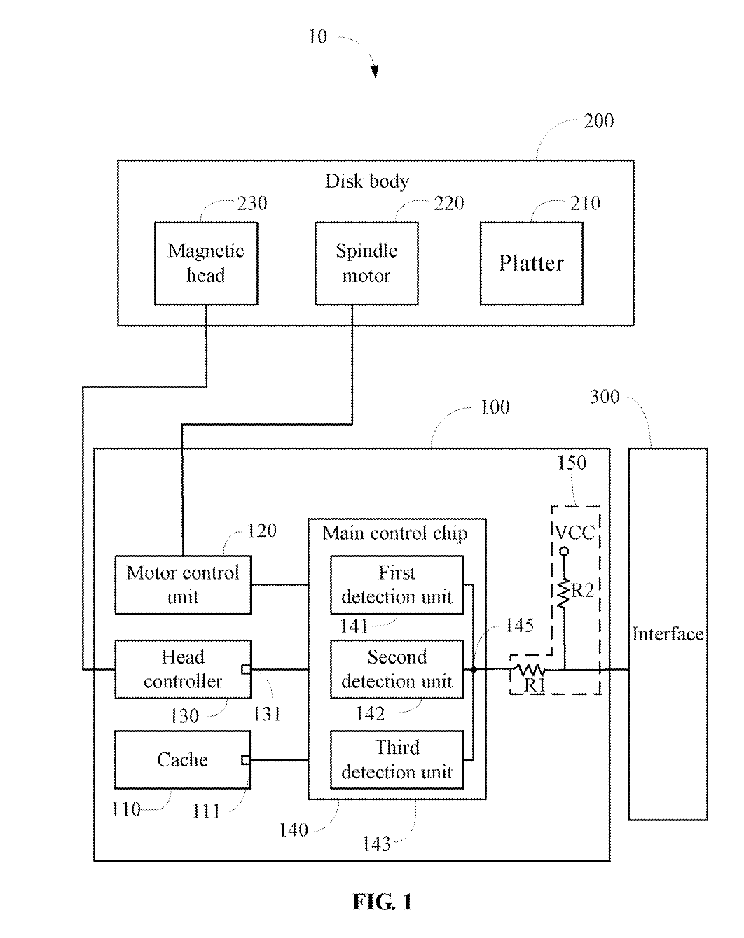

Referring to FIG. 1, a hard disk 10 includes a control circuit 100, a disk body 200, and an interface 300 are shown. The disk body 200 is configured to store data, such as music, images, documents, and other data. The control circuit 100 controls operations of the disk body 200. The interface 300 includes a plurality of connection ports for connecting to external devices. For example, the interface 300 includes a connection port for connecting to a power supply unit (PSU) and a connection port for connecting to a motherboard of a computer system.

The disk body 200 includes a platter 210, a spindle motor 220, and a magnetic head 230. The platter 210 includes a plurality of tracks for storing data. The platter 210 is arranged on a spindle (not shown) driven by the spindle motor 220. The spindle motor 220 drives the platter 210 to rapidly rotate at a predetermined speed on the spindle. The magnetic head 230 moves across the tracks of the platter 210 to read data from the tracks or write data into the tracks.

The control circuit 100 includes a cache 110, a motor control unit 120, a head controller 130, a main control chip 140, and a signal amplifying circuit 150.

The motor control unit 120 drives the spindle motor 220 to rotate the platter 210 according to the predetermined speed. The predetermined speed is determined according to performance capabilities of the hard disk 10 and is prestored in the cache 110.

The head controller 130 controls the magnetic head 230 to move to tracks of the platter 210, to read data from the platter 210, or write data into the platter 210. When the data is read from the platter, the read data is output to the main control chip 140 through a first data transmission port 131 of the head controller 130, and then the main control chip 140 outputs the data to an external device through the interface 300.

The cache 110 temporally stores data transmitted between the splutter 210 and the interface 300. The cache 110 includes a second data transmission port 111 for transmitting the data stored in the cache 210. The cache may be, for example, a random access memory (RAM).

The main control chip 140 detects whether or not each of the cache 110, the platter 210, the spindle motor 220, and the magnetic head 230 are working normally, and outputs one or more signals through the interface 300 when any of the cache 110, the platter 210, the spindle motor 220, and the magnetic head 230 do not work normally. Thus, the external device such as the motherboard connected with the hard disk 10 knows the working state of the hard disk 10, and performs predetermined operations according to the signals. In the embodiment, the main control chip 140 includes a first detection unit 141, a second detection unit 142, a third detection unit 143, and a signal output port 145. The signal output port 145 is electronically connected to the interface 300.

The first detection unit 141 is electronically connected to the motor control unit 120. The first detection unit 141 obtains a current rotating speed of the spindle motor 220 from the motor control unit 120, and compares the current rotating speed of the spindle motor 220 at the predetermined speed to detect whether or not the motor spindle motor 220 is working normally. In this embodiment, when the current rotating speed of the spindle motor 220 is different from the predetermined speed, the first detection unit 141 generates a first signal denoting that the spindle motor 220 is not working normally and outputs the first signal to the interface 300 through the signal output port 145.

The second detection unit 142 is electronically connected to the head controller 131. The second detection unit 142 monitors a logic voltage of the first data transmission port 131 of the head controller 130 to detect whether or not the magnetic head 230 is working normally. In the embodiment, when the logic voltage of the first data transmission port 131 does not change between a logic high voltage (e.g., 3.3V) and a logic low voltage (e.g., 0V) within a predetermined time period, the second detection unit 142 generates a second signal denoting that the magnetic head 230 is not working normally and outputs the second signal to the interface 300 through the signal output port 145.

The third detection unit 143 is electronically connected to the second data transmission port 111 of the cache 110. The third detection unit monitors a logic voltage of the second data transmission port 111 of the cache 110 to detect whether or not the cache 110 is working normally. In the embodiment, when the digital-logic voltage of the second data transmission port 111 does not change between the logic high voltage and the logic low voltage within the predetermined time period, the third detection unit 143 generates a third signal denoting that the cache 110 is not working normally and outputs the third signal to the interface 300 through the signal output port 145.

It is understood that, each of the first, second, and third signals generated as a result of detection may be a logic high signal or a logic low signal. In another embodiment, each of the first, second and third signals may be a square wave signal. When the first, second, and third signals are output to the interface 300, the interface 300 outputs the signals to an external device (e.g., the motherboard) connected to the interface 300.

The signal amplifying circuit 150 is electrically connected between the signal output port 145 and the interface 300, which amplifies the signals output from the signal output port 145 and outputs the amplified signals to the interface 300. In the embodiment, the amplifying circuit 150 includes a voltage dividing resistor R1 and a pull-up resistor R2 which are serially connected with each other. The voltage dividing resistor R1 is connected to the signal output port 145, the pull-up resistor R2 is connected to a power supply pin (VCC), and a node between the voltage dividing resistor R1 and the pull-up resistor R2 is connected to the interface 300.

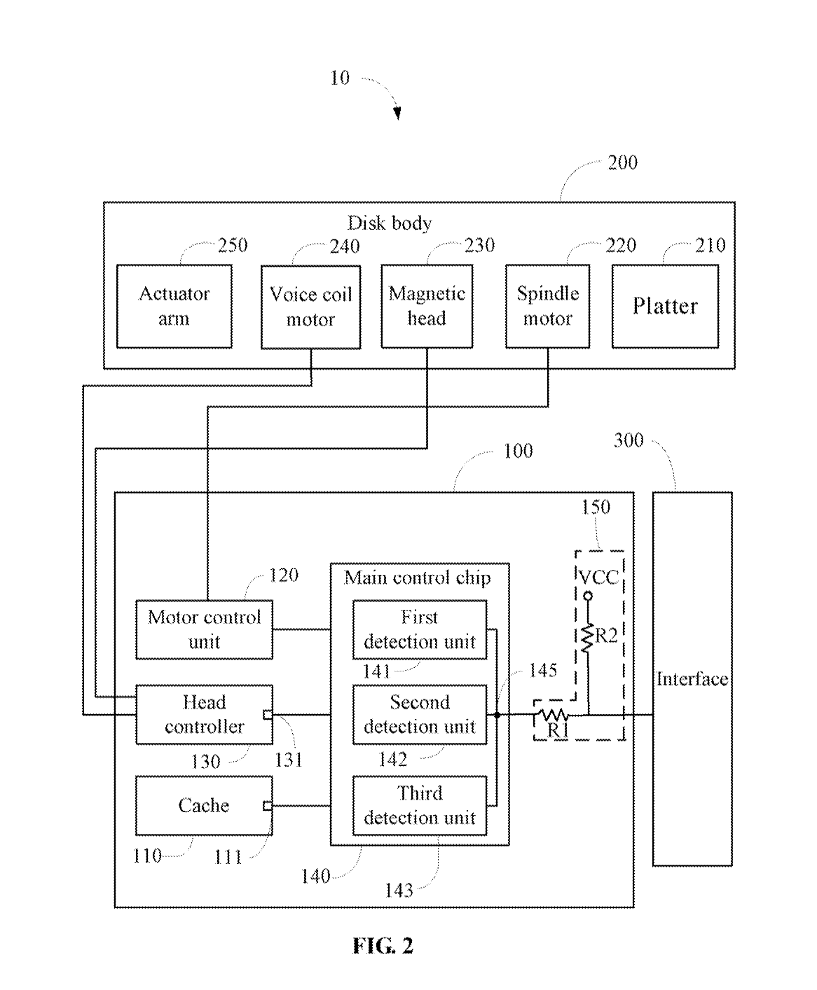

Referring to FIG. 2, a schematic block diagram of the hard disk 10 according to another embodiment is shown. In this embodiment, the hard disk 10 further includes a voice coil motor 240 and an actuator arm 250. The magnetic head 230 is arranged at an end of the actuator arm 250, and the voice coil motor 240 is arranged at another end of the actuator arm 250. The voice coil motor 240 drives the actuator arm 250 to move, thus making the magnetic head 230 move across the platter 210. The magnetic head 230 is capable of moving from one track of the platter 210 to another track of the platter 210 under the driving of the voice coil motor 240.

The head controller 130 is electronically connected to the voice coil motor 240, and outputs a location signal received from the main control chip 140 to the voice coil motor 240. The voice coil motor 240 drives the magnetic head 230 to move to a determined track of the platter 210 using the actuator arm 250, according to the location signal. Then, the head controller 130 detects data in a current track where the head controller 130 is located. The second detection unit 142 thus determines whether or not the current track is the same as the determined track. When the current track is not the same as the determined track, the second detection unit 142 determines that the magnetic head 230 is not working normally and generates the second signal.

Since the main control chip 140 of the hard disk 140 can detect the working states of components of the hard disk 10 to output signals through the interface 300, the motherboard of the computer system using the hard disk 10 knows the working state of the hard disk 10 at all times. Thus, a separate detection circuit designed on the motherboard for monitoring the working state of the hard disk can be omitted, thereby avoiding any influence on other circuits of the motherboard.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A hard disk of a computer system, comprising:
a platter having a plurality of tracks for storing data;
a spindle motor driving the platter to rotate at a predetermined speed;
a magnetic head reading data from the tracks of the platter or writing data into the tracks;
an interface comprising a plurality of connection ports for connecting external devices;
a cache for temporally storing data; and
a main control chip detecting whether or not each of the cache, the platter, the spindle motor, and the magnetic head is working normally, and outputs one or more signals to an external device through the interface when any of the cache, the platter, the spindle motor, and the magnetic head is not working normally.

2. The hard disk according to claim 1, further comprising a motor control unit that drives the spindle motor to rotate the platter at the predetermined speed, and a head controller that controls the magnetic head to move to a corresponding track of the platter, to read data from the platter or write data into the platter.

3. The hard disk according to claim 2, wherein the main control chip comprises a first detection unit electronically connected to the motor control unit, the first detection unit obtains a current rotating speed of the spindle motor from the motor control unit, and compares the current rotating speed of the spindle motor at the predetermined speed to detect whether or not the motor spindle motor is working normally.

4. The hard disk according to claim 3, wherein when the current rotating speed of the spindle motor is different from the predetermined speed, the first detection unit generates a first signal denoting that the spindle motor is not working normally and outputs the first signal to the external device through the interface.

5. The hard disk according to claim 2, where in the main control chip further comprises a second detection unit electronically connected to a data transmission port of the head controller, the second detection unit monitors a logic voltage of the data transmission port of the head controller to detect whether or not the magnetic head works normally.

6. The hard disk according to claim 5, wherein when the logic voltage of the data transmission port of the head controller does not change between a logic high voltage and a logic low voltage within a predetermined time period, the second detection unit generates a second signal denoting that the magnetic head is not working normally and outputs the second signal to the external device through the interface.

7. The hard disk according to claim 5, further comprising a voice coil motor and an actuator arm, the magnetic head is arranged at an end of the actuator arm, the voice coil motor is arranged at another end of the actuator arm, the voice coil motor drives the actuator arm to move the magnetic head across the tracks of the platter.

8. The hard disk according to claim 7, wherein the voice coil motor drives the magnetic head to move to a determined track of the platter using the actuator arm, the head controller detects data in a current track where the head controller is located, and when the current track is not the same as the determined track, the second detection unit generates the second signal denoting that the magnetic head is not working normally and outputs the second signal to the external device through the interface.

9. The hard disk according to claim 1, wherein the main control chip further comprises a third detection unit electronically connected to a data transmission port of the cache, the third detection unit monitors a logic voltage of the data transmission port of the cache to detect whether or not the cache works normally.

10. The hard disk according to claim 9, wherein when the logic voltage of the second data transmission port does not change between a logic high voltage and a logic low voltage within a predetermined time period, the third detection unit generates a third signal denoting that the cache is not working normally and outputs the third signal to the external device through interface.

11. The hard disk according to claim 1, further comprising a signal amplifying circuit electrically connected between the main control chip and the interface, to amplify the signals output from the main control chip and output the amplified signals through the interface.

12. The hard disk according to claim 11, wherein the amplifying circuit comprises a voltage dividing resistor R1 and a pull-up resistor R2 which are serially connected with each other, the voltage dividing resistor R1 is connected to a signal output port of the main control chip, the pull-up resistor R2 is connected to a power supply pin (VCC), and a node between the voltage dividing resistor R1 and the pull-up resistor R2 is connected to the interface.
